(19) United States
(12) Patent Application Publication
(10) Pub. No.: US 2005/0151362 A1
(43) Pub. Date: Jul. 14, 2005

(54) Steering column damping pad

(76) Inventors: Mirjana Jurik, Rochester Hills, MI (US); Jeffrey D. Ottenhoff, Lake Orion, MI (US); Thomas Dziegielewski, Rochester Hills, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 10/754,334

(22) Filed: Jan. 9, 2004

(51) Int. Cl. B62D 1/19

(52) U.S. Cl. 280/777

(57) ABSTRACT

A damping pad for use with a steering column bracket includes a body having a plurality of ribs formed thereon. A plurality of retention posts extend from the body and have a hollow central shaft and a plurality of wings extending radially outwardly therefrom. The wings extend outwardly in a spiral and have a reduced cross section from the hollow central shaft out to an extremity of the wings.

### FIELD OF THE INVENTION

The present invention relates to a steering column damping pad, and more particularly to a steering column damping pad having improved retaining features.

### BACKGROUND OF THE INVENTION

In a typical motor vehicle, vibration and noise are transmitted through the wheels and steering assembly into the steering column assembly of the motor vehicle. In order to minimize and absorb this noise and vibration, steering column assemblies typically include a damping pad mounted on a lower mounting bracket between the lower mounting bracket and the body of the motor vehicle. The damping pad is shaped and designed according to the dimensions of the lower mounting bracket so as to at least partially cover a surface thereof.

Typically, the damping pad is coupled to the lower mounting bracket before transportation to final assembly using posts or plugs. While prior art damping pads have been effective for their intended purpose, there has been a tendency of these prior art damping pads to fall off from the lower mounting bracket during transportation. Specifically, if the posts are too large, they will not fit in sockets formed in the lower mounting brackets. If the posts are too small, they will not retain the damping pad on the lower mounting bracket. Moreover, it is very time consuming and expensive to adapt the plugs to the sockets, either or both of which may vary in size. Therefore, there is room in the art for an improved damping pad having a method of retaining the damping pad to a lower mounting bracket prior to final assembly.

### SUMMARY OF THE INVENTION

A damping pad for use with a steering column bracket includes a body having a plurality of ribs formed thereon. A plurality of retention posts extend from the body and have a hollow central shaft and a plurality of wings extending radially outwardly therefrom. The wings extend outwardly in a spiral and have a reduced cross section from the hollow central shaft out to an extremity of the wings.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a disassembled perspective view of an exemplary steering column bracket having a damping pad constructed according to the principles of the present invention;

FIG. 2 is a perspective view of the damping pad of the present invention;

FIG. 3A is an enlarged cross-sectional view of a retaining post used with the damping pad of the present invention;

FIG. 3B is an enlarged cross-sectional view of a second retaining post used with the damping pad of the present invention;

FIG. 3C is a perspective of a third retaining post used with the damping pad of the present invention; and

FIG. 4 is a perspective view of an alternate damping pad having a fourth retaining post constructed according to the principles of the present invention.

### DETAILED DESCRIPTION OF THE PREFERRED EMBODIMENTS

The following description of the preferred embodiment(s) is merely exemplary in nature and is in no way intended to limit the invention, its application, or uses.

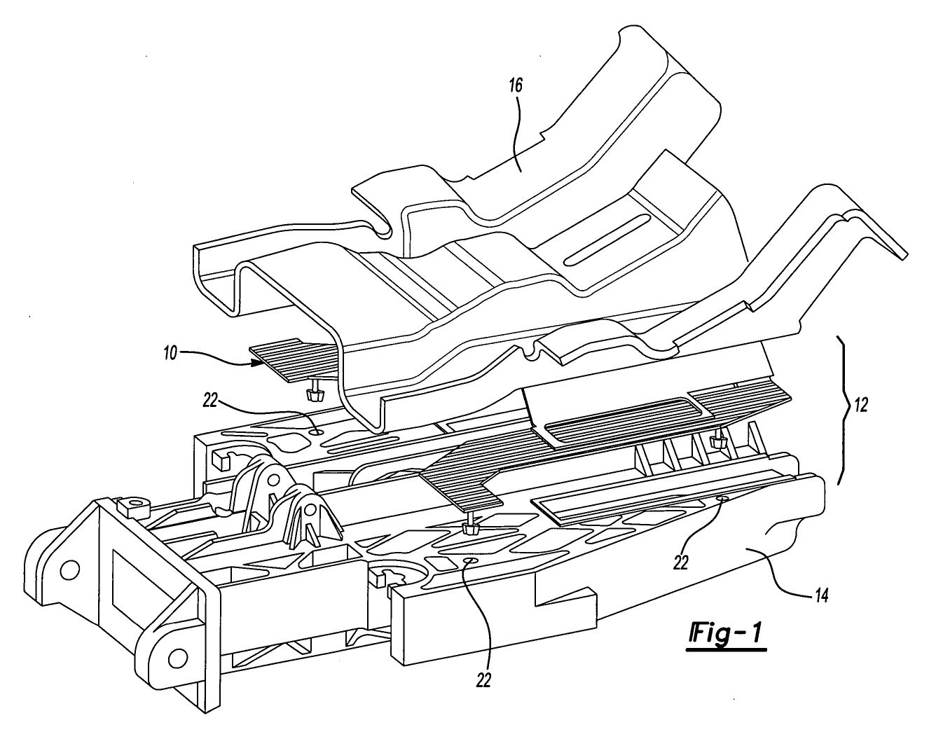

With reference to FIG. 1, a damping pad 10 constructed according to the principles of the present invention is shown in operative association with a steering column assembly 12. The steering column assembly 12 generally includes a lower mounting bracket 14 coupled to an instrument panel mounting bracket 16. The instrument panel mounting bracket 16 is in turn coupled to the body of a motor vehicle (not shown). The damping pad 10 is mounted to the lower mounting bracket 14 between the lower mounting bracket 14 and the instrument panel mounting bracket 16. The damping pad 10 dampens noise and vibration transmitted through the lower mounting bracket 14 to the instrument panel mounting bracket 16.

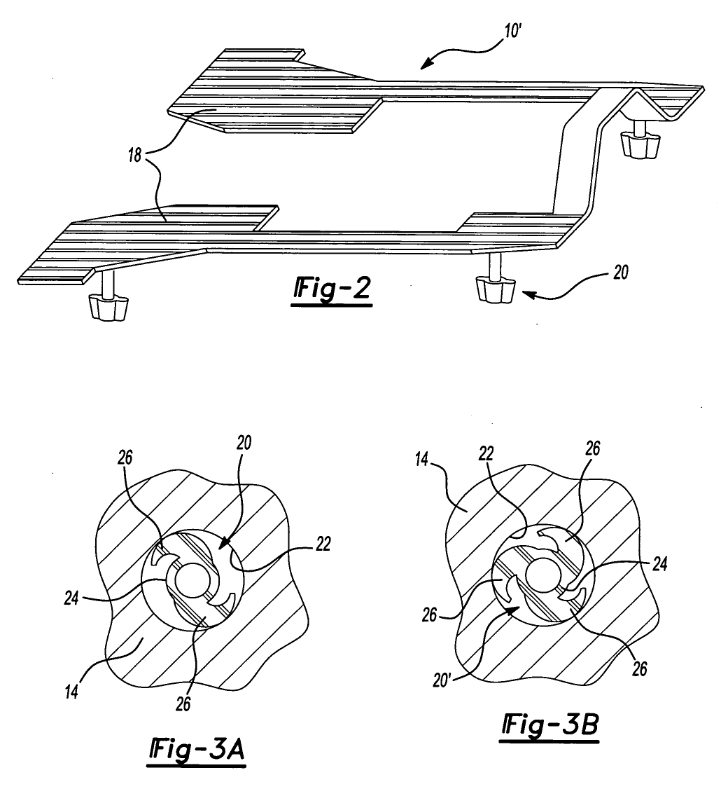

Turning to FIG. 2, the damping pad 10 has a shape that corresponds to the shape of the lower mounting bracket 14. In this regard, the shape of the damping pad 10 may be altered from that shown in the figures without departing from the scope of the present invention. The damping pad 10 includes a body 17 and a plurality of ribs 18 formed on the surface of the damping pad 10. The ribs 18 allow the damping pad 10 to act as a sponge to absorb vibration between the lower mounting bracket 14 and the instrument panel mounting bracket 16. The damping pad 10 is preferably made from an elastic material, such as, for example, rubber, in order to effectively absorb noise and vibration.

The damping pad 10 further includes a plurality of retaining posts 20 for securing the damping pad 10 to the lower mounting bracket 14. The retaining posts 20 are sized to be received within holes 22 (FIG. 1) formed within the lower mounting bracket 14.

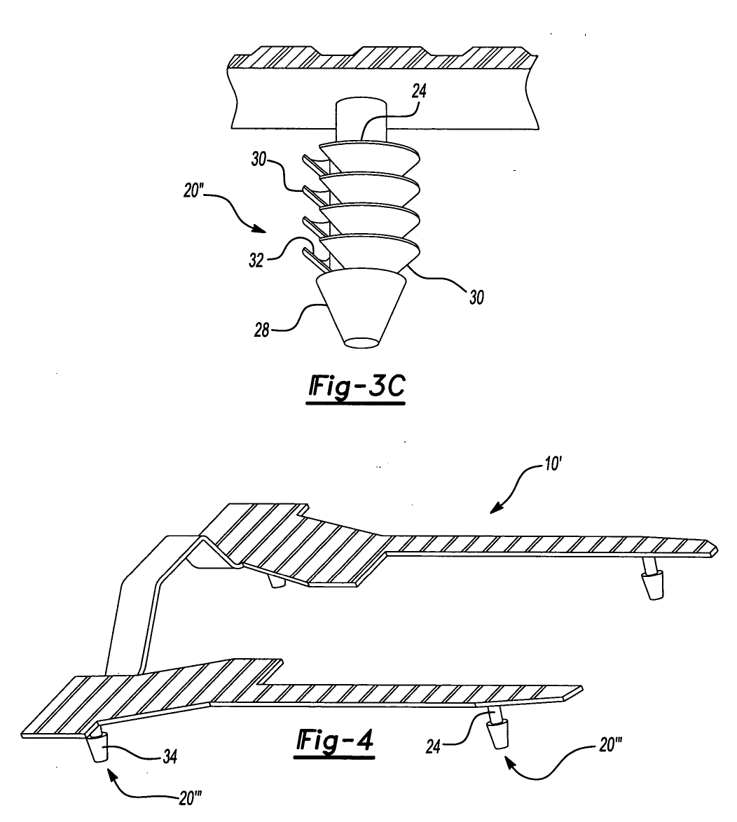

With reference to FIG. 3A, the retaining post 20, only one of which will be described in detail, it being understood that each retaining post is identical to another, includes a hollow central shaft 24 extending from the damping pad 10. A pair of flexible, resilient wings 26 extend radially outward from the hollow central shaft 24. Each wing 26 has a curved shape and projects radially outwardly from opposite sides of the hollow central shaft 24. The wings 26 extend outwardly from the hollow central shaft 24 in a generally spiral arc, which in turn increases their flexibility and capability of being compressed. The wings 26 have a decreasing thickness from the central hollow shaft 24 to the radially outer extremities thereof.

When installing the damping pad onto the lower mounting bracket 14, the retaining posts 20 are inserted into the holes 22. The wings 26 deflect when inserted into the holes 22 and exert a radial force onto the lower mounting bracket 14, thereby holding the damping pad onto the lower mounting bracket 14 using friction force. Minor dimensional variations in the size of the retaining post 20 or holes 22 are of no consequence since the wings 26 are capable of sufficient flexing and compression.

Turning to FIG. 3B, a second design of a retaining post, generally indicated by reference numeral 20′, is generally similar to the retaining post 20, but includes three wings 26 extending radially outwardly from the hollow central shaft 24. The three wings 26 deflect when the retaining post 20′ is inserted into the hole 22 of the lower mounting bracket 14, and exert a radial force onto the lower mounting bracket 14 thereby securing the damping pad 10 to the lower mounting bracket 14.

With reference to FIG. 3C, a third retaining post design, generally indicated by reference numeral 20″, generally includes a tapered nose 28 formed at an end of the hollow central shaft 24 and a plurality of radial baffles 30 formed along the length of the hollow central shaft 24. The radial baffles 30 are stacked one atop another along the length of the hollow central shaft 24. Each radial baffle 30 includes a notch 32 formed therein. The radial baffles 30 deflect in a similar manner to wings 26 (FIGS. 3A, 3B) when the retaining post 20″ is inserted into the holes 22 (FIG. 1) of the lower mounting bracket 14. The radial baffles 30 exert a radial force against the lower mounting bracket 14, thereby securing the damping pad 10 to the lower mounting bracket 14 using friction force. The notches 32 allow the radial baffles 30 ample room to deflect during insertion.

With reference to FIG. 4, an alternate damping pad 10′ having a shape configured to an alternate lower mounting bracket (not shown) includes a plurality of retaining posts 20′″ extending therefrom. The retaining posts 20′″ generally include a nose cone 34 extending from the hollow central shaft 24. The nose cone 34 deflects when inserted into the holes of an alternate mounting bracket (not shown) and exert a radial force thereon. In this way, the damping pad 10′ is secured to the alternate lower mounting bracket (not shown).

The damping pads 10, 10′ overcome the tendency of prior damping pads to fall off of the lower mounting bracket 14 by using the novel retaining posts as described herein. This accomplishment, moreover, is achieved without increasing the size of the damping pad or the cost associated with manufacturing and installing the damping pad.

The description of the invention is merely exemplary in nature and, thus, variations that do not depart from the gist of the invention are intended to be within the scope of the invention. Such variations are not to be regarded as a departure from the spirit and scope of the invention.

1. A retaining post system for use between a damping pad and a steering column bracket comprising:
a hollow central shaft; and
a retention member extending out from said hollow central shaft, said retention member able to compress to retain the damping pad to the steering column bracket.

2. The retaining post of claim 1, wherein said retention member includes a plurality of wings extending radially outwardly from said hollow central shaft in a spiral, said wings having a reduced cross section from said hollow central shaft out to an extremity of said wings.

3. The retaining post of claim 2, wherein said plurality of wings include a pair of wings, each extending out from opposite sides of said hollow central shaft.

4. The retaining post of claim 2, wherein said plurality of wings include three wings, each extending outwards from said hollow central shaft.

5. The retaining post of claim 1, wherein said retention member includes a plurality of radial baffles extending radially outwardly from said hollow central shaft, said radial baffles stacked one atop another along the hollow central shaft.

6. The retaining post of claim 5, wherein said radial baffles each include a notch formed therein for allowing said radial baffles to deflect.

7. A damping pad for use with a steering column bracket comprising:
a body having a plurality of ribs formed thereon; and
a plurality of retention posts extending from said body and having a hollow central shaft and a plurality of wings extending radially outwardly therefrom in a spiral, said wings having a reduced cross section from said hollow central shaft out to an extremity of said wings.

8. The damping pad of claim 7, wherein said wings deflect when inserted into holes formed in the steering column bracket and secure said damping pad to the steering column bracket using friction force.

9. The damping pad of claim 7, wherein said plurality of wings include a pair of wings, each extending out from opposite sides of said hollow central shaft.

10. The damping pad of claim 7, wherein said plurality of wings include three wings, each extending outwards from said hollow central shaft.

11. A damping pad for use with a steering column bracket comprising:
a body having a plurality of ribs formed thereon; and
a plurality of retention posts extending from said body and having a hollow central shaft and a plurality of radial baffles extending radially outwardly therefrom, said radial baffles stacked one atop another along the hollow central shaft.

12. The damping pad of claim 11, wherein said radial baffles deflect when inserted into holes formed in the steering column bracket and secure said damping pad to the steering column bracket using friction force.

13. The damping pad of claim 12, wherein said radial baffles each include a notch formed therein for allowing said radial baffles to deflect.
